(19) United States
(12) Patent Application Publication
(10) Pub. No.: US 2024/0103239 A1
(43) Pub. Date: Mar. 28, 2024

(54) STRENGTH MEMBER ASSEMBLIES AND OVERHEAD ELECTRICAL CABLE INSTALLATIONS INCORPORATING OPTICAL FIBERS

(71) Applicant: CTC Global Corporation, Irvine, CA (US)

(72) Inventors: William Webb, Laguna Niguel, CA (US); Ian M. Pilling, Rancho Santa Margarita, CA (US); Christopher Wong, Santa Ana, CA (US)

(21) Appl. No.: 18/548,979

(22) PCT Filed: Jun. 23, 2021
(86) PCT No.: PCT/US2021/038778

§ 371 Date: Sep. 5, 2023

Related U.S. Application Data
(63) Continuation-in-part of application No. PCT/US21/30016, filed on Apr. 29, 2021.
(60) Provisional application No. 63/157,603, filed on Mar. 5, 2021.

(30) Foreign Application Priority Data
Apr. 29, 2021 (WO) PCT/US2021/030016

(51) Int. Cl. G02B 6/44; H02G 7/05

(52) U.S. Cl. CPC G02B 6/4422; G02B 6/4477; H02G 7/056

(57) ABSTRACT

Electrical transmission and distribution lines and methods for the installation and interrogation of such electrical lines. The electrical lines include overhead electrical cables that include a strength member and at least one optical fiber coupled to the strength member. Termination arrangements are configured to secure the electrical cables to a support tower while enabling the passage of the optical fiber(s) through the termination arrangement without damaging the optical fibers. Optical fibers from two adjacent electrical cable segments may also be fused to enable the interrogation of the two cable segments from a single interrogation device.

### CROSS-REFERENCE TO RELATED APPLICATIONS

This application claims the priority benefit of International PCT Application No. PCT/US2021/030016 filed on Apr. 29, 2021, which is incorporated herein by reference in its entirety. This application also claims the priority benefit of U.S. Provisional Patent Application No. 63/157,603 filed on Mar. 5, 2021, which is incorporated herein by reference in its entirety.

### FIELD

This disclosure relates to the field of overhead electrical cables, particularly configurations and methods for incorporating optical fibers into overhead electrical cables.

### SUMMARY

The present disclosure is directed to electrical transmission and distribution lines, methods for the installation and interrogation of such electrical lines and components for the electrical lines such as cables and termination arrangements. The electrical lines include overhead electrical cables that include a strength member and at least one optical fiber coupled to the strength member. The termination arrangements are configured to secure the electrical cables to a support tower while enabling the passage of the optical fiber(s) through the termination arrangement without damaging the optical fibers. Optical fibers from two adjacent electrical cable segments may also be fused to enable the interrogation of the two cable segments from a single interrogation device.

In one aspect, methods for the installation of an overhead electrical cable are disclosed. In one embodiment, the electrical cable includes a strength member assembly supporting an electrical conductor and at least one optical fiber operatively disposed along a length of the strength member assembly. The method includes the steps of supporting the overhead electrical cable on a plurality of support towers, removing a portion of the electrical conductor from an end segment of the strength member assembly, and securing a gripping assembly to the end segment of the strength member assembly, where a portion of the end segment extends past the gripping assembly. The method further incudes separating an end portion of the optical fiber away from the portion of the end segment of the strength member that extends past the gripping assembly, placing the separated end portion of the optical fiber through a fiber aperture at a distal end of a connector, wherein the connector comprises a fastener, securing the connector to the gripping assembly, crimping a conductive sleeve over the connector and over the electrical conductor, and operatively connecting an interrogation device to the optical fiber.

In another aspect, overhead electrical lines are disclosed. In one embodiment, an overhead electrical line includes an overhead electrical cable supported on a plurality of support towers under mechanical tension where the overhead electrical cable comprises an electrical conductor supported by a strength member. The electrical line includes at least a first termination arrangement securing an end of the overhead electrical cable to a support tower, the termination arrangement having a gripping assembly secured to an end segment of the strength member. An optical fiber extends along the length of the electrical cable and through the gripping assembly and includes an end portion past the gripping assembly that is separated from the strength member. An aperture is disposed at an end of the termination arrangement that is configured to permit access to the optical fiber for the purpose of interrogating the optical fiber.

In another embodiment, an overhead electrical line includes a first segment of an overhead electrical cable, the first segment being secured to a dead-end tower using a first dead-end termination apparatus, the overhead electrical cable comprising an electrical conductor supported by a strength member. A second segment of the overhead electrical cable is secured to the dead-end tower in a substantially different direction than the first segment using a second dead-end termination apparatus. A jumper cable electrically connects the first segment to the second segment. A first optical fiber segment extends from the first electrical cable, through the first dead-end termination apparatus and through a first segment of a protective flexible conduit terminating at a first splice box. A second optical fiber segment extends from the second electrical cable, through the second dead-end termination apparatus and through a second segment of a protective flexible conduit terminating at a second splice box. A third segment of flexible conduit joins the first and second splice box, and a third optical fiber segment extends from the first splice box, though the third segment of flexible conduit, and into the second splice box. The first optical fiber segment and the third optical fiber segment are operatively spliced in the first splice box and the second optical fiber segment and the third optical fiber segment are operatively spliced in the second splice box.

These and other embodiments will be apparent to those skilled in art based on the following description and drawings.

### DESCRIPTION OF THE DRAWINGS

FIG. 1 illustrates an overhead electrical line.

FIGS. 2A and 2B illustrate two examples of an overhead electrical cable having a composite strength member according to the prior art.

FIG. 3 illustrates a strength member including a linear groove for accommodating an optical fiber according to an embodiment of the present disclosure.

FIG. 4 illustrates a strength member including a helical groove for accommodating an optical fiber according to an embodiment of the present disclosure.

FIG. 5 illustrates a strength member assembly having an optical fiber coupled to a strength member according to the present disclosure.

FIG. 6 illustrates a strength member assembly having an optical fiber coupled to a strength member according to the present disclosure.

FIG. 7 illustrates a strength member assembly having an optical fiber coupled to a strength member according to the present disclosure.

FIG. 8 illustrates a strength member assembly having an optical fiber coupled to a strength member according to the present disclosure.

FIG. 9 illustrates a strength member assembly having an optical fiber coupled to a strength member according to the present disclosure.

FIGS. 10A-10C illustrate cross-sectional views of a strength member assembly according to an embodiment of the present disclosure.

FIGS. 11A-11C illustrate cross-sectional views of a strength member assembly according to an embodiment of the present disclosure.

FIG. 12 schematically illustrates a method for the manufacture of a strength member assembly according to an embodiment of the present disclosure.

FIG. 13 illustrates a cross-sectional view of a termination arrangement according to the prior art.

FIG. 14 illustrates a perspective view of a termination arrangement according to the prior art.

FIG. 15 illustrates a cross-sectional view of a termination arrangement according to an embodiment of the present disclosure.

FIGS. 16A-16B illustrate cross-sectional views of a termination arrangement according to an embodiment of the present disclosure.

FIG. 17 schematically illustrates a portion of an electrical line that enables interrogation through an optical fiber(s) across two electrical cable segments.

### DESCRIPTION OF THE EMBODIMENTS

Overhead electrical cables (e.g., for the transmission and/or distribution of electricity) have traditionally been constructed using a steel strength member surrounded by a plurality of conductive aluminum strands that are helically wrapped around the steel strength member, a configuration referred to as “aluminum conductor steel reinforced” (ACSR). Recently, overhead electrical cables having a fiber-reinforced composite strength member have been manufactured and deployed in many electrical lines. As compared to steel, the fiber-reinforced composite materials used for the strength member have a lighter weight and lower thermal expansion.

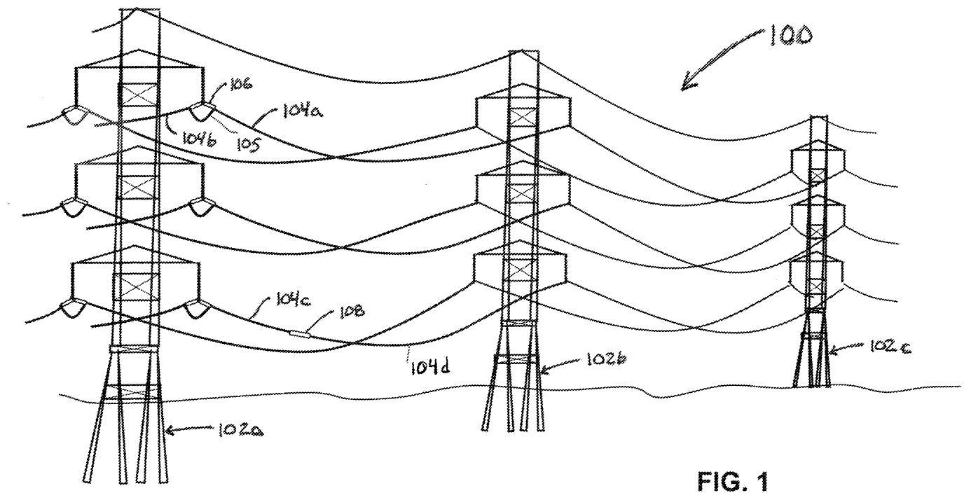

FIG. 1 illustrates a portion of an overhead electrical transmission line 100 for the transmission of electricity. Overhead electrical transmission and distribution lines are constructed by elevating bare, or covered, electrical cables (e.g., electrical cable 104a) above the terrain using support towers (e.g., pylons) such as support towers 102a/102b/102c. The transmission and distribution lines may span many miles, requiring extremely long lengths of electrical cable and many support towers. Some of the support towers are referred to as dead-end towers or anchor towers, such as tower 102a. Such towers are located at termination points, e.g., power substations or locations where the electrical line is routed underground. Dead-end towers such as tower 102a may also be required where the electrical line changes direction (e.g., makes a turn), crosses a roadway or other structure where there is a high risk of damage or injury if the cable fails, or at regular intervals in a long, straight line path. In such instances, the overhead electrical cable must be terminated (e.g., severed), secured to the dead-end tower under high tension and electrically connected to an adjacent overhead electrical cable. As illustrated in FIG. 1, electrical cable segment 104a is secured (e.g., anchored) to tower 102a using a dead-end termination apparatus 106a (e.g., a tension clamp) and is electrically connected to an adjacent electrical cable 104b through a jumper 105, e.g., where the adjacent electrical cable 104b extends in a in a substantially different direction than the first electrical cable segment 104a.

Another termination structure is referred to as a cable splice. While the length of a single segment of overhead cable may cover several thousand feet, a power grid may require several hundred miles of electrical cable. To span these distances, the linemen must often splice (e.g., couple) two shorter cable segments together. Thus, one or more cable splices may be placed between two dead ends of an overhead cable installation. The cable splice functions as both a mechanical junction that holds the two ends of the cables together and an electrical junction allowing the electric current to flow through the cable splice. As illustrated in FIG. 1, a cable splice 108 operatively connects electrical cable segment 104c to electrical cable segment 104d to form a mechanical junction and a continuous electrical pathway.

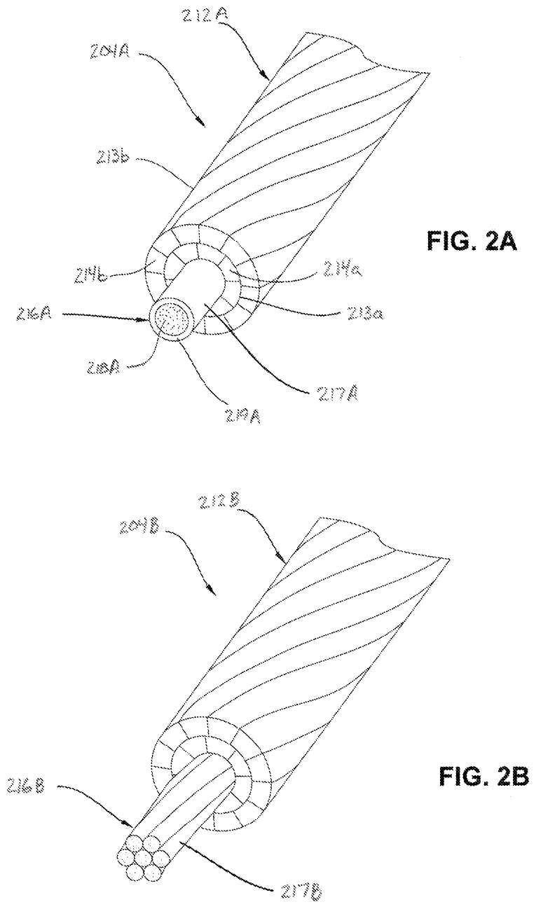

FIG. 2A illustrates a perspective view of an electrical cable with a portion of the electrical conductor removed to show the underlying components, e.g., the strength member assembly including a strength member. In the configuration illustrated in FIG. 2A, the fiber-reinforced composite strength member includes a single fiber-reinforced composite strength element (e.g., a single rod). An example of such a configuration is disclosed in U.S. Pat. No. 7,368,162 by Hiel et al., which is incorporated herein by reference in it is entirety. Alternatively, the composite strength member may be comprised of a plurality of individual fiber-reinforced composite strength elements (e.g., individual rods) that are operatively combined (e.g., twisted or stranded together) to form the strength member, as is illustrated in FIG. 2B. Examples of such multi-element composite strength members include, but are not limited to: the multi-element aluminum matrix composite strength member illustrated in U.S. Pat. No. 6,245,425 by McCullough et al.; the multi-element carbon fiber strength member illustrated in U.S. Pat. No. 6,015,953 by Tosaka et al.; and the multi-element strength member illustrated in U.S. Pat. No. 9,685,257 by Daniel et al. Each of these U.S. patents is incorporated herein by reference in its entirety. Other configurations for the fiber-reinforced composite strength member may be implemented as is known to those skilled in the art.

Referring to the overhead electrical cable illustrated in FIG. 2A, the electrical cable 204A includes an electrical conductor 212A that includes a first conductive layer 213a and a second conductive layer 213b, each comprising a plurality of individual conductive strands (e.g., strands 214a and 214b) that are helically wrapped around a fiber-reinforced composite strength member 216A. It will be appreciated that such overhead electrical cables may include a single conductive layer, or more than two conductive layers, depending upon the desired use of the overhead electrical cable. The conductive strands may be fabricated from conductive metals such as copper or aluminum, and for use in bare overhead electrical cables are typically fabricated from aluminum, e.g., hardened aluminum, annealed aluminum, or aluminum alloys. The conductive strands illustrated in FIG. 2A have a substantially trapezoidal cross-section, although other configurations may be employed, such as circular cross-sections. The use of polygonal cross-sections such as the trapezoidal cross-section advantageously increases the cross-sectional area of conductive metal for the same effective cable diameter, e.g., as compared to strands having a circular cross-section.

The conductive materials, e.g., aluminum, do not have sufficient mechanical properties (e.g., sufficient tensile strength) to be self-supporting when strung between support towers to form an overhead electrical line for transmission and/or distribution of electricity. In this regard, the strength member 216A supports the conductive layers 213a/213b when the overhead electrical cable 204A is strung between the support towers under high mechanical tension. In the embodiment illustrated in FIG. 2A, the strength member 216A includes a single (e.g., only one) strength element 217A. The strength element 217A includes a fiber-reinforced composite core 218A of high strength carbon reinforcing fibers in a binding matrix, and a galvanic layer 219A disposed around the fiber-reinforced composite core 218A to prevent contact between the carbon fibers and the first conductive layer 213a, e.g., to prevent galvanic corrosion of the aluminum in the conductive layer 213a.

FIG. 2B illustrates an embodiment of an overhead electrical cable 204B that is similar to the electrical cable illustrated in FIG. 2A, where the strength member 216B supporting the electrical conductor 212B comprises a plurality of individual strength elements (e.g., strength element 217B) that are stranded or twisted together to form the strength member 216B. Although illustrated in FIG. 2B as including seven individual strength elements, it will be appreciated that a multi-element strength member may include any number of strength elements that is suitable for a particular application.

As noted above, the fiber-reinforced composite material from which the strength elements, e.g., the high tensile strength core, are constructed may include reinforcing fibers that are operatively disposed in a binding matrix. The reinforcing fibers may be substantially continuous reinforcing fibers that extend along the length of the fiber-reinforced composite, and/or may be short reinforcing fibers (e.g., fiber whiskers or chopped fibers) that are dispersed through the binding matrix. The reinforcing fibers may be selected from a wide range of materials including, but not limited to, carbon, glass, boron, metal oxides, metal carbides, high-strength polymers such as aramid fibers or fluoropolymer fibers, basalt fibers and the like. Carbon fibers are particularly advantageous in many applications due to their very high tensile strength, and/or due to their relatively low coefficient of thermal expansion (CTE).

The binding matrix may include, for example, a plastic (e.g., polymer) such as a thermoplastic polymer or a thermoset polymer. For example, the binding matrix may include a thermoplastic polymer, including semi-crystalline thermoplastics. Specific examples of useful thermoplastics include, but are not limited to, polyether ether ketone (PEEK), polypropylene (PP), polyphenylene sulfide (PPS), polyetherimide (PEI), liquid crystal polymer (LCP), polyoxymethylene (POM, or acetal), polyamide (PA, or nylon), polyethylene (PE), fluoropolymers and thermoplastic polyesters.

The binding matrix may also include a thermosetting polymer. Examples of useful thermosetting polymers include, but are not limited to, epoxy, bismaleimides, polyetheramides, benzoxazine, thermosetting polyimides (PI), polyether amide resin (PEAR), phenolic resins, epoxy-based vinyl ester resins, polycyanate resins and cyanate ester resins. In one exemplary embodiment, a vinyl ester resin is used in the binding matrix. Another embodiment includes the use of an epoxy resin, such as an epoxy resin that is a reaction product of epichlorohydrin and bisphenol A, bisphenol A diglycidyl ether (DGEBA). Curing agents (e.g., hardeners) for epoxy resins may be selected according to the desired properties of the fiber-reinforced composite strength member and the processing method. For example, curing agents may be selected from aliphatic polyamines, polyamides and modified versions of these compounds. Anhydrides and isocyanates may also be used as curing agents. Other examples of thermosetting polymeric materials useful for a binding matrix may include addition cured phenolic resins, polyetheramides, and various anhydrides, or imides.

The binding matrix may also be a metallic matrix, such as an aluminum matrix. One example of an aluminum matrix fiber-reinforced composite is illustrated in U.S. Pat. No. 6,245,425 by McCullough et al., noted above.

When the strength member includes a galvanic layer, the galvanic layer may also be formed from reinforcing fibers, e.g., glass fibers, in a binding matrix. Alternatively, the galvanic layer may be formed from a plastic, e.g., a thermoplastic having high temperature resistance and good dielectric properties to insulate the underlying carbon fibers from the aluminum layers.

One configuration of a composite strength member for an overhead electrical cable that is particularly advantageous is the ACCC® composite configuration that is available from CTC Global Corporation of Irvine, CA and is illustrated in U.S. Pat. No. 7,368,162 by Hiel et al., noted above. In the commercial embodiment of the ACCC® electrical cable, the strength member is a single element strength member of substantially circular cross-section that includes a core of substantially continuous reinforcing carbon fibers disposed in a polymer matrix. The core of carbon fibers is surrounded by a robust insulating layer of glass fibers that are also disposed in a polymer matrix and are selected to insulate the carbon fibers from the surrounding conductive aluminum strands. See FIG. 2A. The glass fibers also have a higher elastic modulus than the carbon fibers and provide bendability so that the strength member and the electrical cable can be wrapped upon a spool for storage and transportation.

A desire has been expressed for overhead electrical cables that incorporate optical fibers, either for interrogation (e.g., inspection) of the cable during and/or after installation, or for telecommunications (e.g., data transmission). For overhead electrical cables that include a fiber-reinforced composite strength member, such as those described above, there is a desire to interrogate the cable after installation to ensure the integrity of the cable along its length. Because of the extreme lengths of these cables, it would also be desirable to identify the location of any anomalies, e.g., defects or fractures, identified by the interrogation, such as by using optical time domain reflectometry (OTDR), Brillouin optical time domain reflectometry (BOTDR) or similar analysis techniques. See, for example, PCT Publication No. WO2020/181248 by Wong et al., which is incorporated herein by reference in its entirety.

The present disclosure is directed to configurations that include the placement of one or more optical fibers, e.g., glass optical fibers, within the structure of the overhead electrical cable. More particularly, the configurations include strength member assemblies that include at least one optical fiber that is operatively coupled to the strength member, e.g., on an outer surface of one or more of the strength elements. It is an objective to disclose configurations of strength member assemblies and of overhead electrical cables that maintain the integrity of the optical fibers, e.g., that prevent or minimize damage to the optical fibers during manufacture and in use. It is also an objective to disclose configurations of strength member assemblies and of overhead electrical cables that enable the optical fiber(s) to be readily located at one or both ends of the overhead electrical cable, and to be at least partially separated from the overhead electrical cable at the end, so that a light transmission device (e.g., a coherent light transmission device such as a laser) and/or detection device may be operatively attached to the optical fiber(s).

It is noted that in the figures that follow, the optical fiber is not shown to scale relative to the electrical cable for purposes of illustration.

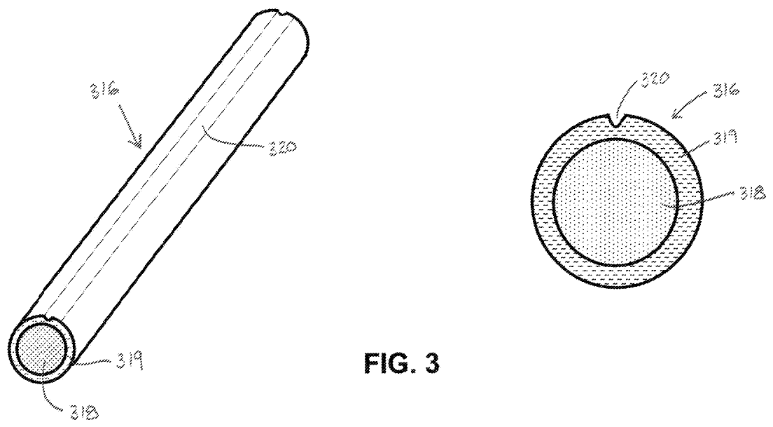

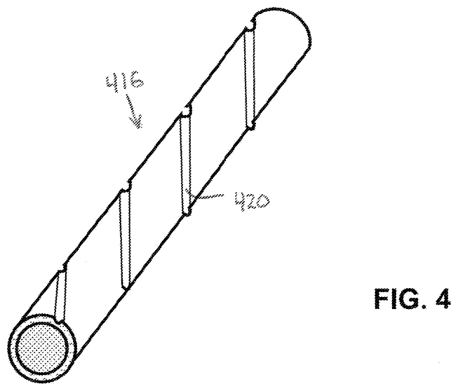

FIG. 3 illustrates an embodiment of a strength member 316 according to an embodiment of the present disclosure. The strength member 316 includes a high tensile strength fiber-reinforced composite core 318 including carbon fibers in a binding matrix and a galvanic layer 319 comprised of glass fibers in a binding matrix. The strength element includes a groove 320 that runs along the length of the strength member 316. The groove 320 is configured (e.g., sized and shaped) to retain one or more optical fibers within the groove 320. In this manner, all or substantially all of the optical fiber(s) may be disposed in the groove 320 without protruding substantially above the surface of the strength member 316. FIG. 4 illustrates a strength member 416 that includes a groove 420 that is similar to that illustrated in FIG. 3, but where the groove is helically disposed about the strength member 416.

In either embodiment, the width of the groove should be sufficient to enable the placement of at least one optical fiber within the groove, and the depth of the groove should be sufficient to enable the optical fiber to be disposed substantially below the surface of the strength member. In one characterization, the groove has a width that is substantially similar to, or slightly greater than, the width of the optical fiber so that the optical fiber may be friction fit within the groove. Stated another way, the optical fiber and the groove may have dimensions such that the outer circumference of the optical fiber may gently contact the sidewalls of the groove when the optical fiber is placed within the groove. A typical glass optical fiber has an outer diameter of from about 150 μm to about 500 μm including the plastic jacket(s) that typically surrounds the glass core of the fiber. Thus, the groove may have a width of at least about 100 μm such as at least about 120 μm. However, the groove should not be larger than necessary to accommodate an optical fiber, or several optical fibers if desired, and in one construction the groove has a width of not greater than about 500 μm, such as not greater than about 400 μm. Similarly, the depth of the groove will typically have dimensions that are similar to the width. The shape of the groove may be circular (e.g., with rounded bottom and sidewalls) or may be polygonal (e.g., with squared-off sidewalls and bottom). In certain configurations, as described below, the optical fiber may have a greater width, e.g., up to about 1 mm, and in such constructions the width of the groove may be up to about 1 mm or up to about 900 μm to accommodate the larger diameter optical fiber.

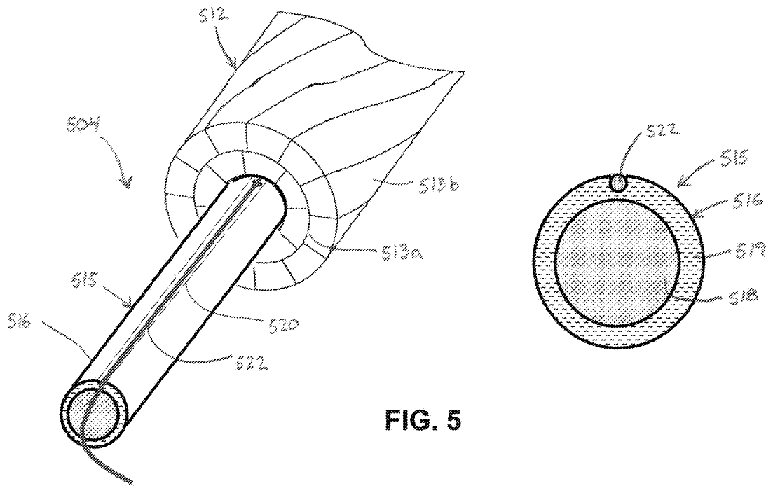

Optical fiber grooves such as those illustrated in FIGS. 3 and 4 may be implemented with any of the embodiments illustrated above, including the embodiment illustrated in FIG. 2. By way of example, FIG. 5 illustrates an embodiment of an electrical cable 504 and a strength member assembly 515 utilizing a strength member such as that illustrated in FIG. 3. The electrical cable 504 includes a strength member 516 that includes a single strength element comprising a high tensile strength fiber-reinforced composite core 518 including carbon fibers in a binding matrix and a galvanic layer 519 of glass fibers in a binding matrix. An electrical conductor 512 surrounds the strength member 516 and includes a first conductive layer 513a and a second conductive layer 513b. In the embodiment illustrated in FIG. 5, an optical fiber 522 is linearly disposed in a groove 520 that is formed along an outer surface of the strength member 516 to form the strength member assembly 515. In this manner, although the optical fiber 522 is disposed on the surface of the strength member 516 with no intervening material layer between the optical fiber 522 and the conductive layer 513a, the groove 520 substantially prevents the optical fiber from being significantly damaged when, for example, the conductive layer 513a is stranded over the strength member 516. A similar strength member assembly configuration to that illustrated in FIG. 5 may be implemented with a helically coupled optical fiber, e.g., using the strength member illustrated in FIG. 4. In one implementation, the optical fiber is bonded within the groove using an adhesive or similar material, particularly a high temperature adhesive. For example, a high temperature epoxy may be used. Similarly, a thermoplastic or a polyamide may be used to secure the optical fiber within the groove.

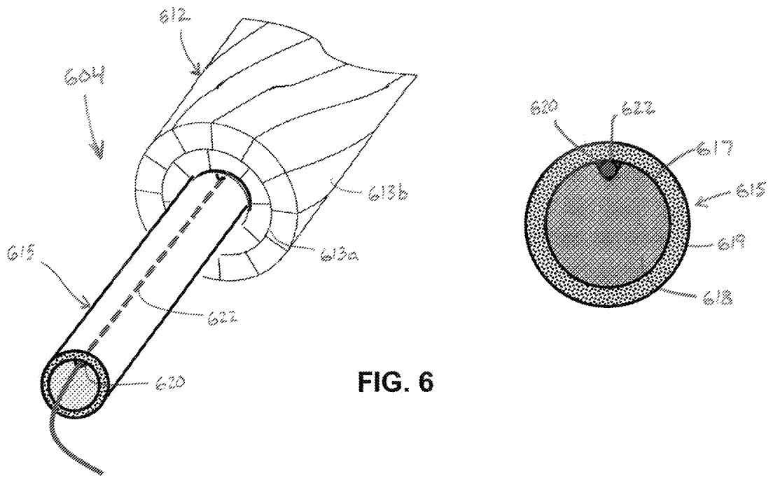

Although disposing the optical fiber in a groove as illustrated in FIG. 5 may provide some protection for the optical fiber, it may still be desirable or necessary to provide additional material layer to further protect the optical fiber. Merely by way of example, FIG. 6 illustrates a perspective view of an electrical cable 604 and a cross-sectional view of a strength member assembly 615 including strength member 616 and an optical fiber 622 disposed in a groove 620. The strength member 616 comprises a high tensile strength fiber-reinforced composite core 618 including carbon fibers in a binding matrix. An electrical conductor 612 surrounds the strength member 616 and includes a first conductive layer 613a and a second conductive layer 613b. In the embodiment illustrated in FIG. 6, an optical fiber 622 is linearly disposed in a groove 620 that is formed along an outer surface of the strength element 617. A plastic layer 619 is disposed over and surrounds the strength element 617 and the optical fiber 622 to form the strength member assembly 615. The plastic layer 619 may comprise (e.g., be formed from) a high-performance plastic, e.g., having a continuous service temperature of at least about 150° C., such as at least about 180° C., at least about 200° C. or even at least about 220° C. In one characterization, the high-performance plastic layer is a thermoplastic, e.g., a semi-crystalline thermoplastic. In another characterization, the high-performance plastic layer is formed from a thermoplastic selected from polyetheretherketone (PEEK) and polyphenylene sulfide (PPS). Other plastic materials such as fluorocarbon polymers, e.g., polytetrafluoroethylene, may also be useful, as well as high-performance amorphous plastics such as amorphous polyetherimide (PEI). The plastic layer may also be fabricated from an elastomer having good thermal resistance properties, such as an elastomeric silicone. The plastic layer may have a thickness of at least about 1 mm, such as at least about 2 mm. Typically, the thickness of the plastic layer will be not greater than about 10 mm.

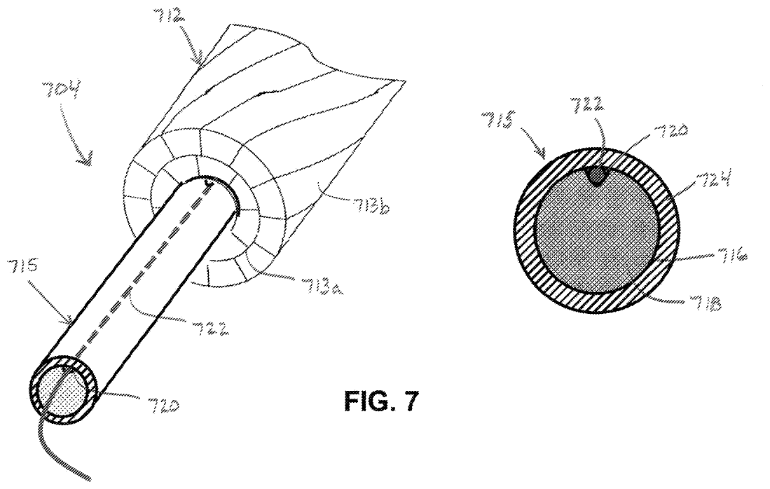

As another example, FIG. 7 illustrates a perspective view of an electrical cable 704 and a cross-sectional view of a strength member assembly 715 including strength member 716 and an optical fiber 722 disposed in a groove 720. The strength member 716 comprises a high tensile strength fiber-reinforced composite core 718 including carbon fibers in a binding matrix. An electrical conductor 712 surrounds the strength member 716 and includes a first conductive layer 713a and a second conductive layer 713b. In the embodiment illustrated in FIG. 7, an optical fiber 722 is linearly disposed in a groove 720 that is formed along an outer surface of the strength member 716. A metallic conformal layer 724 is disposed over and surrounds the strength member 716 and the optical fiber 722 to form the strength member assembly 715.

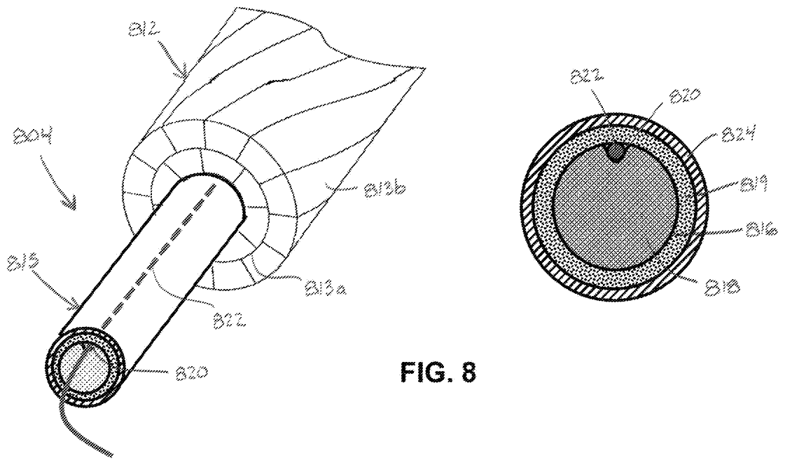

FIG. 8 illustrates a perspective view of an electrical cable 804 and a cross-sectional view of a strength member assembly 815 including strength member 816 and an optical fiber 822 disposed in a groove 820. The strength element 817 comprises a high tensile strength fiber-reinforced composite core 818 including carbon fibers in a binding matrix. An electrical conductor 812 surrounds the strength member 816 and includes a first conductive layer 813a and a second conductive layer 813b. In the embodiment illustrated in FIG. 8, an optical fiber 822 is linearly disposed in a groove 820 that is formed along an outer surface of the strength element 817. A plastic layer 819 is disposed over and surrounds the strength member 816 and the optical fiber 822. A metallic conformal layer 824 is disposed over and surrounds the plastic layer 819 to form the strength member assembly 815.

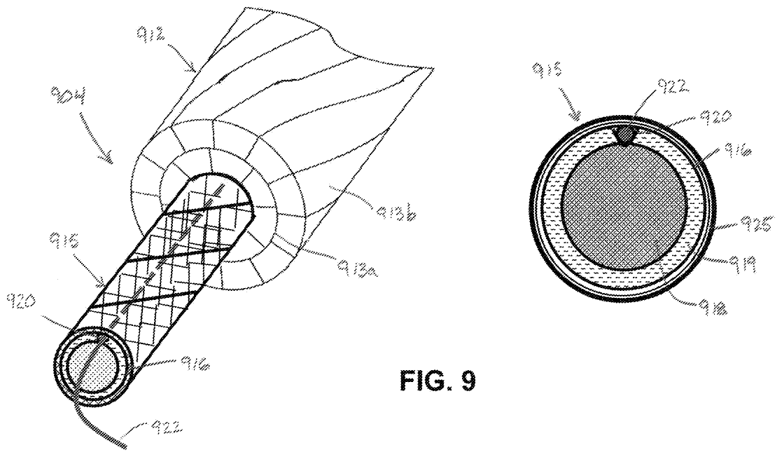

FIG. 9 illustrates a perspective view of another embodiment of an electrical cable 904 and a cross-sectional view of a strength member assembly 915 that includes a strength member 916 and an optical fiber 922 disposed in a groove 920. The strength element comprises a high tensile strength fiber-reinforced composite core 918 including carbon fibers and a galvanic layer 919 surrounding the composite core 918. An electrical conductor 912 surrounds the strength member 916 and includes a first conductive layer 913a and a second conductive layer 913b. In the embodiment illustrated in FIG. 9, an optical fiber 922 is linearly disposed in a groove 920 that is formed along an outer surface of the strength member 916. A tape layer 925 is helically wrapped around and surrounds the strength member 916 and the optical fiber 922 to form the strength member assembly 915. The tape layer 925 may comprise (e.g., be formed from) a pressure-sensitive adhesive (PSA) on a backing material, for example. In one construction, the tape layer is formed from a heat-resistant meta-aramid fiber, such as NOMEX tape (DuPont de Nemours, Inc., Wilmington, DE, USA), e.g., a substrate of aramid fiber having an adhesive on one surface of the substrate. The tape layer may have a thickness that is sufficient to protect the optical fiber from substantial damage. For example, the tape layer may have a thickness of at least about 0.05 mm, such as at least about 0.1 mm, and not greater than about 3 mm, such as not greater than about 2 mm.

In any of the foregoing embodiments incorporating a groove in the strength member, the optical fiber(s) may be tightly fit, e.g., friction fit, within the groove by careful selection of the groove width relative to the diameter of the optical fiber. Alternatively, or in addition, the optical fiber may be secured in the groove using means such as an adhesive (e.g., a flowable adhesive or an adhesive tape).

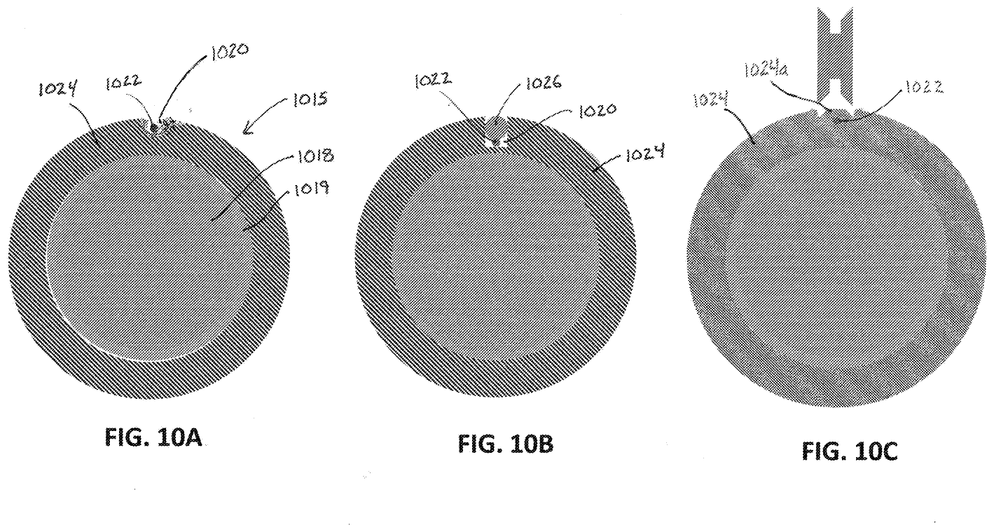

In another embodiment, the strength member assembly includes optical fiber(s) are operatively coupled to the strength member by being bonded to the conformal metallic layer, e.g., onto or beneath the outer surface of a conformal metallic layer. FIGS. 10A to 10C illustrate cross-sectional views of such an embodiment. The strength member assembly 1015 includes a strength member 1016 having a high tensile strength core 1018 and a galvanic layer 1019 surrounding the high tensile strength core 1018. A metallic conformal layer 1024, e.g., formed from aluminum, surrounds the strength member 1016. A groove 1020 is formed in the conformal metallic layer 1024, e.g., is formed along a surface of the conformal layer 1024. The optical fiber 1022 is operatively disposed within the groove along a length of the strength member assembly 1015.

The optical fiber 1022 may be tightly fit, e.g., friction fit, within the groove 1020 by careful selection of the groove width relative to the diameter of the optical fiber 1022. Alternatively, or in addition, the optical fiber 1022 may be secured in the groove using means such as an adhesive (e.g., a flowable adhesive or an adhesive tape). As illustrated in FIG. 10B, a length of a plastic filament 1026 (e.g., a wire or thread) such as a thermoplastic or elastomeric filament may be tightly placed within the groove and over the optical fiber 1022. In the embodiment illustrated in FIG. 10C, a portion 1024a of the metallic conformal layer 1024 is collapsed over the groove to secure the optical fiber 1022 in the groove and couple the optical fiber to the conformal layer 1024. In an alternative to the embodiment illustrated in FIG. 10C, the groove on the surface of the metallic conformal layer 2134 may be formed with nubs, e.g., a raised portion, on one or both sides of the groove that are then folded over the groove after the optical fiber 1022 is disposed in the groove 1020.

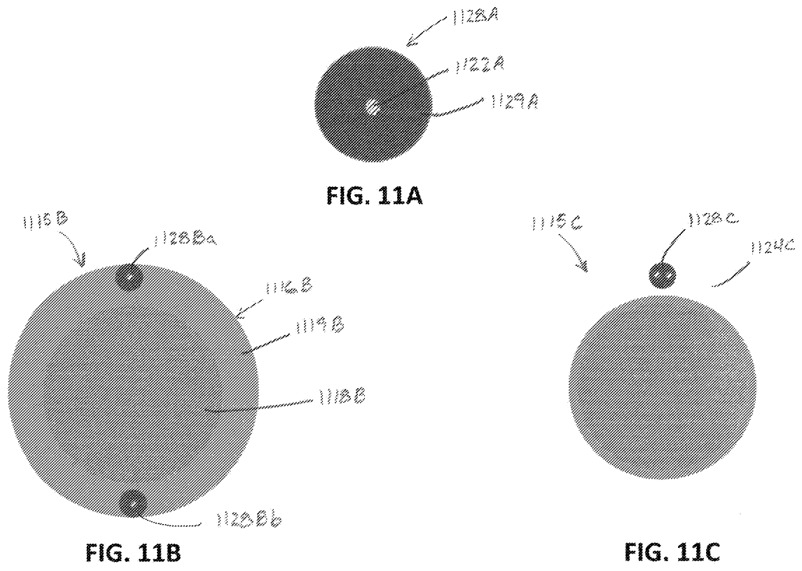

Another embodiment of the present disclosure relates to a construction for a glass optical fiber where the glass optical fiber includes a relatively thick plastic coating (e.g., a layer or a jacket) to protect the glass core and glass cladding of the optical fiber from damage. As illustrated in FIG. 11A, the large diameter coated optical fiber 1128A includes a glass optical fiber 1122A that is coated (e.g., surrounded by) a relatively thick high-performance plastic coating 1129A. In one characterization, the high-performance plastic coating 1129A is a thermoplastic, e.g., a semi-crystalline thermoplastic. In one refinement, the high-performance plastic coating 1129A is a thermoplastic selected from a polyetheretherketone (PEEK) coating and a polyphenylene sulfide (PPS) coating. Other plastic coatings such as fluorocarbon polymers, e.g., polytetrafluoroethylene, may also be useful, as well as high-performance amorphous plastics such as amorphous polyetherimide (PEI). The high-performance plastic coating 1129A may have a relatively large outer diameter as compared to most commercially available optical fibers. For example, the high-performance plastic coating 1129A may have an outer diameter of at least about 500 μm, such as at least about 700 μm or even at least about 900 μm. Typically, the outer diameter will be not greater than about 2 mm, such as not greater than about 1.5 mm to avoid displacing a significant amount of material (e.g., reinforcing fiber) from the strength member. It should be noted that the foregoing high-performance plastic coating is distinct from, e.g., in addition to, the typical buffer coatings that are applied to a glass optical fiber, as is described below.

The large diameter coated optical fiber 1128A may be coupled to the strength member in any manner disclosed above. For example, large diameter coated optical fiber 1128A may be coupled directly to the strength member, e.g., may be coupled to a galvanic layer. For example, as illustrated in FIG. 11B, the large diameter coated optical fiber 1128Ba may extend along the length of the strength member 1116B. Specifically, the strength member 1116B includes a high strength composite core 1118B and a glass fiber galvanic layer 1119B, where the large diameter coated optical fiber 1128Ba is disposed within the galvanic layer. While the large diameter coated optical fiber 1128Ba may be placed in a pre-formed groove, the relatively thick plastic coating may enable the large diameter coated optical fiber 1128Ba to be integrally formed with the strength member 1116B, e.g., by being pultruded with the reinforcing fibers (e.g., carbon and/or glass fibers) that form the strength member 1116B. As illustrated in FIG. 11B, the strength member assembly 1115B also includes a second large diameter coated optical fiber 1128Bb that is similar in construction to large diameter coated optical fiber 1128a.

FIG. 11C illustrates an alternative construction where the large diameter coated optical fiber 1128C is disposed within the conformal metallic layer 1124C, e.g., in manner similar to the embodiment illustrated in FIG. 10A. The embodiment illustrated in FIG. 11C also illustrates that the large diameter coated optical fiber 1128C may include two or more glass fibers, e.g., two distinct glass core and glass cladding portions, within a single outer high-performance plastic coating.

The embodiment of a large diameter coated optical fiber disclosed with respect to FIGS. 11A-11C advantageously facilitates the identification of the optical fiber due to the relatively large outer diameter of the construction. The large diameter optical fiber may be readily identified and separated from the strength member assembly. Once separated, the outer coating, e.g., of high-performance plastic, may be stripped from the fiber.

The foregoing embodiments are subject to various characterizations with respect to the configurations and selection of materials for the components, some of which are noted above. The optical fibers disclosed in the foregoing figures may be characterized in several ways. The term “optical fiber” used herein refers to an elongate and continuous fiber that is configured to transmit incident light down the entire length of the fiber. Typically, optical fibers will include a glass transmissive core and a glass cladding layer surrounding the core that is fabricated from a different material (e.g., having a different refractive index) to reduce the loss of light out of the transmissive core, e.g., through the exterior of the optical fiber. This is in contrast to, for example, a structural fiber (e.g., a structural glass fiber) that has a homogenous composition and is typically placed in a composite material as a fiber tow, i.e., an untwisted bundle of individual filaments.

The glass optical fibers used in the strength element can be, for example, single mode optical fibers or multimode optical fibers. A single mode optical fiber has a small diameter transmissive core (e.g., about 9 μm in diameter) surrounded by a cladding having a diameter of about 125 μm. Single mode fibers are configured to allow only one mode of light to propagate. A multimode optical fiber has a larger transmissive core (e.g., about 50 μm in diameter or larger) that allows multiple modes of light to propagate. Typical glass optical fibers are also supplied with one or more coatings surrounding the glass cladding, e.g., plastic coatings, which act as a buffer, e.g., to increase resistance to damage from micro-bending. Typical coating materials include plasticized polyvinyl chloride (PVC), low/high density polyethylene (LDPE/HDPE), nylon, and polysulfone.

The tape layer(s) illustrated herein, may be pressure-sensitive adhesive (PSA) tapes that include an adhesive layer on one side of the tape, e.g., on the side that is placed onto the strength element. Examples include, but are not limited to, heat resistant aramid fiber tapes such as Nomex® and fiberglass tape. Although described above as a tape, the layer does not necessarily include an adhesive, particularly when the tape layer is tightly wound around the circumference of the strength element. For example, the tape layer may comprise a randomly-oriented fiber mat of fibers such as polyester fibers. Such fiber mats may be particularly useful for holding the optical fiber(s) on the strength member until a subsequent material layer (e.g., a plastic layer and/or a metallic conformal layer) is disposed over the strength element and the optical fiber. In another characterization, the tape layer includes a surface (e.g., the surface contacting the strength element) that is roughened (e.g., includes grit) to enhance the grip of the tape layer onto the strength element, e.g., by an increase in the friction between the tape layer and the strength element. In another characterization, the tape layer may comprise a plastic tape that is heat shrunk onto the strength member. In another characterization, the tape layer may comprise a cylindrical, helically wound biaxial braid that lengthens and narrows when the braid is pulled on, e.g., similar to a “Chinese finger trap” or Kellems grip.

The plastic layers, disclosed herein, may be formed from a variety of plastics (i.e., polymers) including thermoset or thermoplastic polymers, including but not limited to polyetheretherketone (PEEK) and polyphenylene sulfide (PPS). Plastics having good heat resistance and a high dielectric constant are particularly useful. The plastic layer will typically have a thickness of at least about 1.0 mm and not greater than about 10 mm.

The metallic conformal layers disclosed herein may be formed from a variety of metals, with aluminum and aluminum alloys being particularly useful. Typically, the metallic conformal layer will have a thickness of at least about 1.0 mm and not greater than about 15 mm.

A difficulty associated with the use of glass optical fibers is that although the theoretical strain to failure of a glass optical fiber is typically about 6% to 8%, randomly formed flaws (e.g., surface defects) along the glass optical fiber significantly reduce the actual strain to failure due to stress concentrations at those flaws, e.g., where a flaw creates a weak point that is susceptible to failure at significantly lower strains. This becomes a significant issue over the extreme lengths of an overhead electrical cable, e.g., hundreds to thousands of meters. Although glass optical fibers may be proof-tested for minimum tensile strain, this has been found to be inadequate for the lengths of optical fibers required for use with overhead electrical cables. For example, when a strength member is tightly wrapped around a spool for storage and transport, the entire length of the strength member is placed under constant strain, which may result in a failure of the optical fiber if a single flaw of sufficient size is subjected to that strain.

In one embodiment of the present disclosure, the glass optical fiber is placed, e.g., intentionally placed, in a stress state when the glass fiber is coupled (e.g., operatively joined) to the strength member. As used herein, the terms coupled or operatively joined mean that the glass optical fiber is placed on or within the strength member in a manner that stress loads applied to the strength member are transferred to the glass optical fiber. According to this embodiment, the glass optical fiber coupled to the strength member is in a state of compressive strain and is maintained in a state of compressive strain, e.g., by being bonded to the strength member. For example, the optical fiber may be in a state of compressive strain even when the strength member itself is in a substantially neutral strain state.

As a result, when a tensile strain is applied to the strength member, such as by wrapping the strength member around a storage spool, the applied tension will have to overcome the compressive strain in the glass optical fiber before the optical fiber will be subjected to a tensile strain. Merely by way of example, if the optical fiber is under a compressive strain of about 0.7%, and the strength member is subjected to a tensile strain of about 1.2%, the optical fiber will only be subjected to a tensile strain of about 0.5%.

Thus, in one embodiment, an elongate strength member assembly configured for use as a central support in an overhead electrical cable is disclosed. The strength member assembly includes at least a strength member and at least one optical fiber coupled to the strength member. Specifically, the strength member assembly includes an elongate strength member having a high tensile strength core and an optical fiber operatively coupled to the strength member, wherein at least a length of the optical fiber that is coupled to the strength member is in a state of compressive strain. It will be appreciated that this embodiment, i.e., where the optical fiber is under a compressive strain, may be implemented with any of the strength member assemblies disclosed above.

In one characterization, the length of optical fiber is under a compressive strain of at least about 0.2%, such as at least about 0.5%, or even at least about 0.75%. Typically, the compressive strain will be not greater than about 2%. In one particular characterization, the compressive strain is at least about 0.75% and is not greater than about 1.5%. The length of optical fiber that is under compressive strain may extend along substantially the entire length of the strength member. For example, the length of optical fiber under compressive strain may be at least about 100 meters, at least about 250 meters, at least about 500 meters, at least about 1000 meters, or even at least about 2500 meters.

As noted above, the optical fiber is bonded to the strength member in a manner that substantially maintains the optical fiber in a state of compressive strain, and in a manner that the applied strain, e.g., applied tensile strain, experienced by the strength member is transferred to the optical fiber. The optical fiber may be bonded to a surface of the high tensile strength core, e.g., to the strength element, or may be bonded to a conformal metallic layer, such as an aluminum conformal layer. Merely by way of example, the optical fiber may be bonded to the high tensile strength core using an adhesive, such as by an adhesive tape that is disposed over the optical fiber, e.g., a pressure sensitive adhesive tape. The length of optical fiber may also be disposed within a groove formed along a length of the surface of the high tensile strength core. The optical fiber may be disposed within the groove with an adhesive or with a plastic material such as an elastomer or may be disposed within the groove without an adhesive or plastic material. In one configuration, a conformal metallic layer is placed over the high tensile strength core and the optical fiber

In an alternative construction, the length of optical fiber may be bonded to the metallic conformal layer, e.g., bonded to the surface of the conformal metallic layer. For example, the metallic conformal layer may include a groove formed along it surface wherein the length of optical fiber is disposed within the groove. The length of optical fiber may be mechanically bonded within the groove by a portion of the conformal layer that extends over the groove, e.g., as is illustrated in FIG. 10C. Alternatively, or additionally, the length of optical fiber may be bonded to the conformal metallic layer using an adhesive, such as an adhesive tape, or using a plastic such as a thermoplastic that is placed into the groove with the optical fiber

In one implementation, the optical fiber includes a high-performance plastic coating surrounding the optical fiber. For example, the high-performance plastic coating may have a continuous service temperature of at least about 150° C., such as at least about 180° C., at least about 200° C., or even at least about 220° C. In one characterization, the high-performance plastic coating is a thermoplastic, e.g., a semi-crystalline thermoplastic. In another characterization, the high-performance plastic coating is a thermoplastic selected from a polyetheretherketone (PEEK) coating and a polyphenylene sulfide (PPS) coating.

In another embodiment, an overhead electrical cable is disclosed where the overhead electrical cable includes a strength member assembly as disclosed above, i.e., including a strength member assembly having a glass optical fiber under compressive strain, and having at least a first layer of conductive strands wrapped around the support assembly.

In another embodiment, a method for the manufacture of a strength member assembly including a glass optical fiber under compressive strain is disclosed. The method includes the steps of placing a portion of an elongate strength member under tensile strain, operatively coupling an optical fiber to the portion of the strength member that is under tensile strain, and releasing the tensile strain on the portion of the strength member, wherein the optical fiber is placed in a state of compressive strain when the tensile strain on the portion of the strength member is released

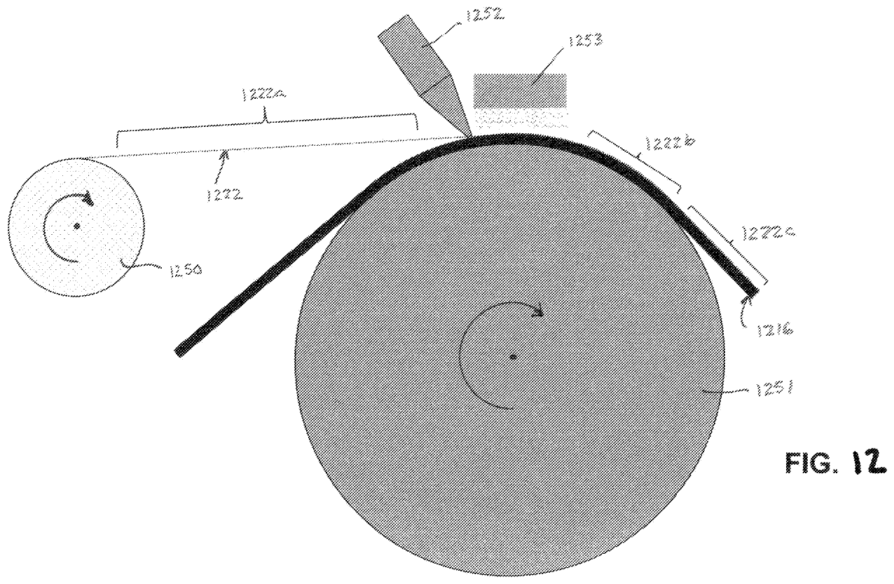

In one implementation the method includes the use of a bending wheel to place the strength member under tension as the optical fiber is coupled to the strength member. As illustrated in FIG. 12, the glass optical fiber 1222 is dispensed from a spool 1250, e.g., as the spool rotates. Alternatively, the optical fiber 1222 may be dispensed from a package that does not require rotation of a spool, as is known to those of skill in the art. As the optical fiber 1222 is dispensed and before the optical fiber is contacted with the strength member 1216, the optical fiber 1222a is preferably in a substantially strain free state. That is, the optical fiber is placed under little back-tension as it is dispensed, with only enough tension being applied to ensure control of the payout from the spool. The strength member 1216 is contacted with the bending wheel 1251 as the bending wheel rotates and is tensioned against the bending wheel 1251 which places the strength member 1216 (e.g., the top surface of the strength member) into a state of tension. The amount of tension applied to the strength member 1216 may be controlled by selecting the diameter of the bending wheel 1251.

As the optical fiber 1222 contacts the strength member 1216, the optical fiber is bonded to the strength member by applying an adhesive from a dispenser 1252. For example, the adhesive may be an ultraviolet (UV) curable adhesive, in which case an ultraviolet source 1253 may be used to rapidly cure the adhesive. Alternative methods may be used to bond (e.g., to couple) the optical fiber 1222 to the strength member 1216. For example, a heat curable adhesive may be employed. In another implementation, the optical fiber 1222 includes a thermoplastic coating to enable melt bonding of the optical fiber to the strength member 1216. As is noted above, the optical fiber 1222 may be placed in a groove formed in the strength member 1216. As the strength member 1216 and the optical fiber 1222, now coupled to the strength member, release from the bending wheel 1251 the strength member straightens out and puts the bonded optical fiber into a compressive strain state, e.g., the portion of the optical fiber 1222c.

Although the strength member assemblies illustrated above include a single strength element to which an optical fiber is coupled, it will be appreciated that the strength member may include a plurality of strength elements, e.g., as is illustrated in FIG. 2B. In this configuration, one or more optical fibers may be coupled to a single strength element, or optical fibers may be coupled to more than one strength element as may be desired for increased accuracy and/or measurement redundancy.

One advantage of the placement of the optical fiber(s) on the outer surface of the strength member (e.g., of a strength element) is that this configuration facilitates the identification and isolation of the optical fibers at the end of the electrical cable, e.g., as is illustrated in the figures above. That is, to connect to optical fibers to transmission and/or detection devices, the ends of the optical fibers must be spliced, e.g., mechanically spliced or fusion spliced, to make the necessary connections. Because the optical fibers are small (e.g., about 125 μm to about 250 μm), they may be difficult to locate particularly during a field installation.

Typically, when a connection to an optical fiber is desired, the outer conductive layers (e.g., the conductor strands) are first cut away from the strength member assembly to expose an end portion of the strength member assembly. Thereafter, the optical fibers must be located and isolated, e.g., where a length of the optical fiber is separated from the strength member assembly while retaining the integrity of the optical fiber. According to certain embodiments, the protective layers (e.g., the tape layer, the plastic layer, and/or the metallic conformal layer) may be gently stripped (e.g., peeled) away to locate the optical fiber(s). Thereafter, the optical fiber may be operatively connected to an interrogation device (e.g., an OTDR device) or to a telecommunications device by splicing, e.g., by fusion splicing.

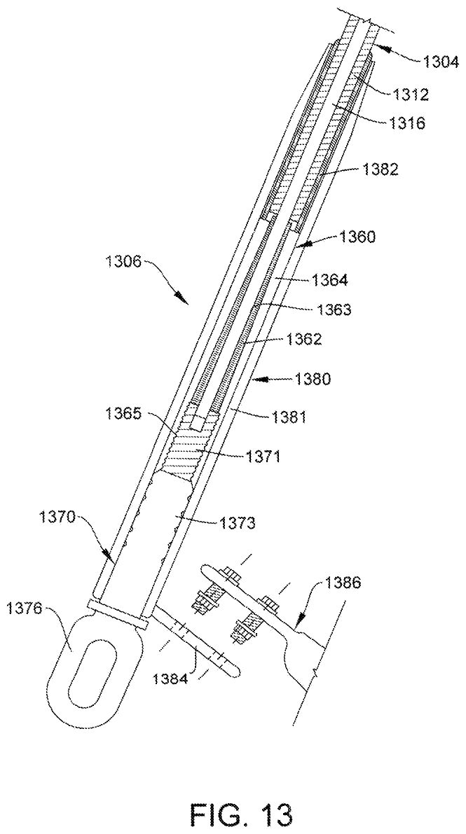

FIG. 13 illustrates a cross-section of an assembled termination apparatus (e.g., a dead-end) for use with a bare overhead electrical cable, e.g., such as dead-end 106 in FIG. 1. The termination apparatus 1306 illustrated in FIG. 2 is similar to that illustrated and described in PCT Publication No. WO 2005/041358 by Bryant and in U.S. Pat. No. 8,022,301 by Bryant et al., each of which is incorporated herein by reference in its entirety.

Broadly characterized, the termination apparatus 1306 illustrated in FIG. 13 includes a gripping assembly 1360 and a connector 1370 for anchoring the termination apparatus 1306 to a dead-end structure, e.g., to a tower as illustrated in FIG. 1 with a fastener 1376 (e.g., an eyebolt) disposed at a proximal end of the termination apparatus 1306. At the end of the termination apparatus 1306, opposite the fastener 1376, the termination apparatus is operatively connected to an overhead electrical cable 1304 that includes an electrical conductor 1312 (e.g., comprising conductive strands) that surrounds and is supported by a strength member 1316, e.g., a fiber-reinforced composite strength member.

The gripping assembly 1360 tightly grips the strength member 1316 to secure the overhead electrical cable 1304 to the termination apparatus 1306. As illustrated in FIG. 13, the gripping assembly 1360 includes a compression-type fitting (e.g., a wedge-type fitting), specifically a collet 1362 having a lumen 1363 (e.g., a bore) that surrounds and grips onto the strength member 1316. The collet 1362 is disposed in a collet housing 1364, and as the electrical cable 1304 is tensioned (e.g., is pulled onto support towers), friction develops between the strength member 1316 and the collet 1362 as the collet is pulled further into the collet housing. The conical (outer) shape of the collet 1362 and the mating inner funnel shape of the collet housing 1364 create increased compression on the strength member 1316, ensuring that the strength member does not slip out of the collet 1362 and therefore that the overhead electrical cable 1304 is secured to the termination apparatus 1306.

As illustrated in FIG. 13, an outer sleeve 1380 is disposed over the gripping assembly 1360 and includes a conductive sleeve body 1361 to facilitate electrical conduction between the electrical conductor 1312 and a jumper plate 1384. An inner sleeve 1382 (e.g., a conductive inner sleeve) may be placed between the conductor 1312 and the conductive body 1381 to facilitate the electrical connection between the conductor and the conductive body. The conductive body 1381 may be fabricated from aluminum, and the jumper plate 1384 may be welded onto the conductive body 1381, for example. The jumper plate 1384 is configured to attach to a connector plate 1386 to facilitate electrical conduction between the electrical conductor 1312 and another conductor, e.g., another electrical cable (not illustrated) that is in electrical communication with the connector plate 1386.

The connector 1370 includes a fastener 1376 and gripping element mating threads 1371 disposed at a gripping element end 1372 of the connector body 1373. The gripping element mating threads 1371 are configured to operatively mate with connector mating threads 1365 of the collet housing 1364 to facilitate movement of the connector 1370 toward the collet 1362, pushing the collet 1362 into the collet housing 1364, when the threads 1365 and 1371 are engaged and the connector 1370 is rotated relative to the collet housing 1364. This strengthens the grip of the collet 1362 onto the strength member 1316, further securing the overhead electrical cable 1304 to the termination apparatus 1306. The fastener 1376 is configured to be attached to a dead-end structure, e.g., to a dead-end tower, to secure the termination apparatus 1306 and the electrical cable 1304 to the dead-end structure. See FIG. 1.

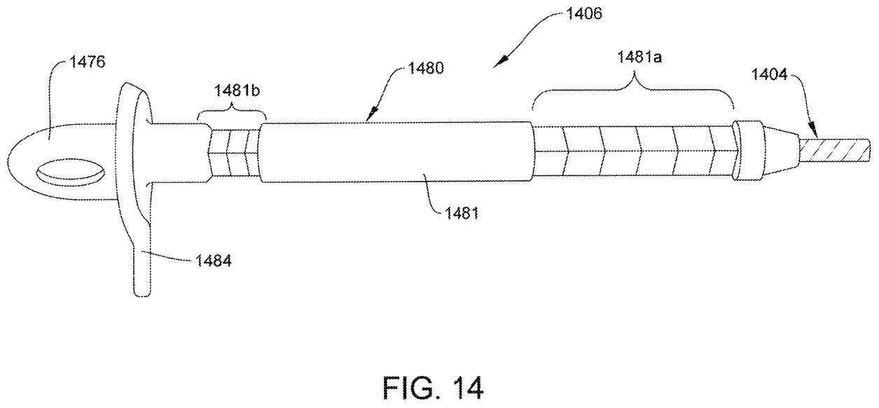

FIG. 14 illustrates a perspective view of a termination apparatus, similar to the termination apparatus of FIG. 13, that has been crimped (e.g., compressed) onto an overhead electrical cable. The termination apparatus 1406 includes a connector having a fastener 1476 that extends outwardly from a proximal end of an outer sleeve 1480. A jumper plate 1484 is integrally formed with the outer conductive sleeve body 1481 for electrical connection to a connection plate (e.g., see FIG. 13). As illustrated in FIG. 14, the outer sleeve body 1481 is crimped over (e.g., onto) two regions of the underlying structure, namely crimped sleeve body region 1481b and crimped sleeve body region 1481a. The crimped sleeve body region 1481b is generally situated over an intermediate portion of the underlying connector (e.g., see FIG. 13), and the crimped sleeve region 1481a is generally situated over a portion of the overhead electrical cable 1404. The compressive forces placed onto the outer sleeve body 1481 during the crimping operation are transferred to the underlying components, i.e., to the connector under the crimped region 1481b and to the overhead electrical cable 1404 under the crimped region 1481a to permanently secure the termination apparatus 1406 to the electrical cable 1404.

The termination apparatus broadly described with respect to FIGS. 13 and 14 can be utilized with various bare overhead electrical cable configurations. The termination apparatus illustrated in FIGS. 13 and 14 are particularly useful with overhead electrical cables having a fiber-reinforced composite strength member. For example, a compression wedge gripping element, e.g., having a collet disposed in a collet housing (e.g., FIG. 13), enables a fiber-reinforced composite strength member to be gripped under a high compressive force without significant risk of fracturing the composite material.

No matter the function of the optical fibers, it will be necessary to access the fibers, e.g., to reliably introduce light into the ends of the optical fibers, and to detect and/or analyze light emanating from the optical fibers. However, as can be seen in FIGS. 13 and 14, when the overhead electrical cable is terminated at a dead end (i.e., using a termination arrangement described above), the end of the strength member, and therefore the ends of the optical fibers, can no longer be accessed to pass a signal into the optical fibers and/or to detect a light signal emanating from the optical fibers.

It is one object of the present disclosure to provide hardware such as a termination arrangement (e.g., a dead-end or a splice) for use with an overhead electrical cable that enables access to an end of the strength member and to optical fibers disposed therein, even after the overhead electrical cable has been installed, e.g., after a span of the overhead electrical cable has been strung and terminated.

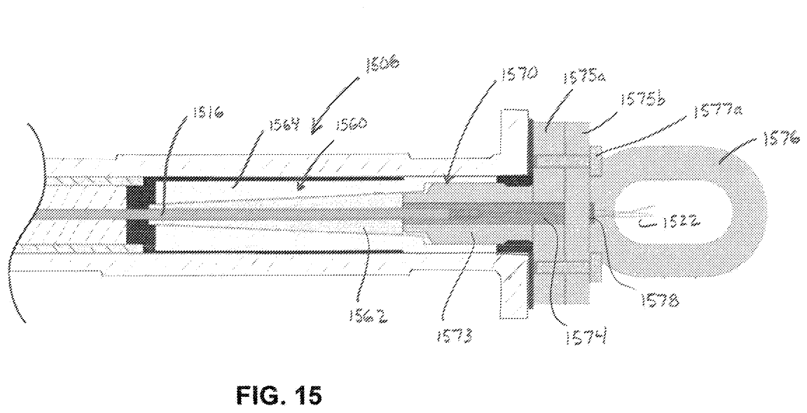

FIG. 15 illustrates a cross-sectional view of an embodiment of a termination apparatus according to the present disclosure. The termination apparatus 1506 includes a gripping assembly 1560 in the form of a collet 1562 and collet housing 1564 that grip onto the strength member 1516. In this embodiment, the optical fiber(s) 1522 extend through the collet 1562 with the strength member 1516. In this regard, the connector body 1573 includes a connector body port 1574 (e.g., a bore) extending longitudinally through the connector body 1573. As illustrated in FIG. 15, the connector 1570 includes a first flange 1575a which may be integrally formed with the connector body 1573. The fastener 1576 includes a second flange 1575b that is secured to the first flange 1575a by a plurality of flange bolts such as flange bolt 1577a. The optical fibers extend through the connector body port 1574 and through an optical fiber aperture 1578 disposed through the second flange 1575b so that an end of the optical fibers 1522 may protrude through the aperture 1578 to be accessed. In this embodiment, the optical fibers 1522 may be inserted through the aperture 1578 before the flange 1575b and the fastener 1576 are secured to the flange 1575a. A grommet (e.g., a rubber grommet) may be utilized to reduce the strain on the optical fibers 1522 as they exit the aperture 1578.

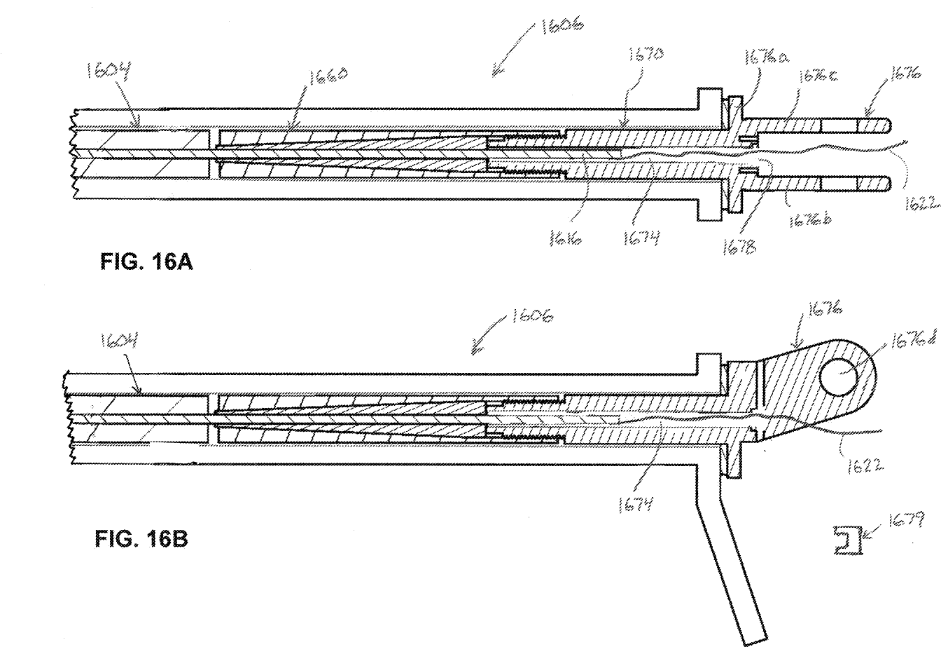

FIGS. 16A and 16B illustrate another embodiment of a termination arrangement according to the present disclosure. The termination arrangement 1606 generally includes a gripping assembly 1660 that is operatively attached to a connector 1670 having a connector body port 1674 through which and end segment of the strength member 1616 is disposed. The fastener 1676 is a clevis-type fastener having a clevis base 1676a and two spaced-apart clevis prongs 1676b/1676c extending from the base 1676a. A clevis aperture 1676d extends through both prongs to enable a bolt to be affixed to the prongs for connection to a dead-end structure. An end portion of an optical fiber 1622 is separated from an end portion of the strength member 1616 and extends past the strength member 1622 and through a fiber aperture 1678 located at the connector end of the termination arrangement 1606. In this manner, the optical fiber may be operatively connected to an interrogation device even after the termination arrangement 1606 has been operatively affixed to the electrical cable 1604, e.g., after the electrical cable 1604 is fully tensioned on the support towers.

A cap 1679 (e.g., a removable cap) may be attached over the aperture 1678 to seal the aperture 1678, e.g., after the optical fiber 1622 is fully placed within the port 1674, e.g., for later access to the optical fiber 1622 and to seal (e.g., hermetically seal) the port 1674 and the end of the optical fiber 1622 disposed therein. For example, the cap 1679 may be threaded, friction fit, and/or held in place by one or more fasteners. In the embodiment illustrated in FIGS. 16A and 16B, the clevis aperture 1676d is offset from a longitudinal axis of the strength member 1616, e.g., offset from the longitudinal axis of the port 1674. More particularly, the clevis aperture 1676d is centrally disposed in the prongs 1676b/1676c, and the prongs are disposed at an angle with respect to the connector 1670. In this manner, the optical fiber 1622 may be accessed (e.g., after removal of the cap 1679) without necessitating the detachment of the termination arrangement 1606 from the support tower or extending the clevis prongs.

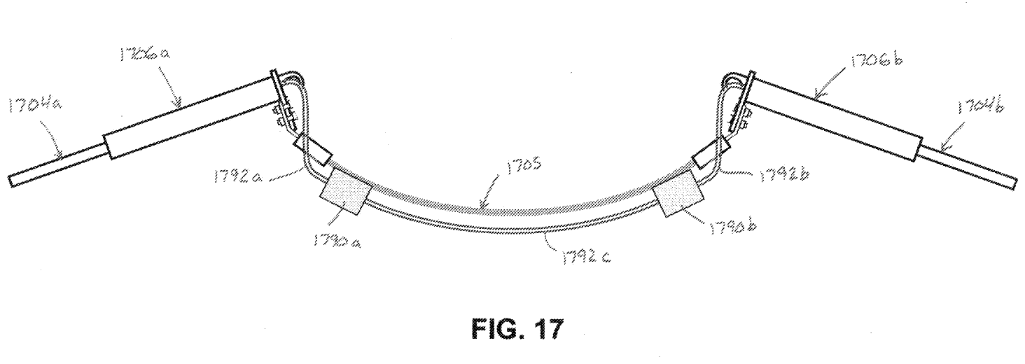

The embodiments disclosed herein may also enable the interrogation of an electrical cable using one or more optical fibers along a substantial length of the electrical cable. More specifically, the embodiments disclosed herein enable the interrogation of two or more cable segments that are joined at a support tower. See cable segments 104a and 104b illustrated in FIG. 1, for example, that are electrically joined by jumper cable 105. FIG. 17 schematically illustrates a portion of an electrical line (e.g., an electrical transmission line) including a junction enabling such interrogation. The electrical line includes electrical cable segments 1704a and 1704b that are joined at a dead-end support tower (not illustrated). Specifically, the first cable segment 1704a is secured to a first termination arrangement 1706a and the second cable segment 1704b is secured to a second termination arrangement 1706b. Each termination arrangement is secured to the same dead-end tower, and each enables passage of optical fibers through the termination arrangement, e.g., as is illustrated in FIGS. 15 and 16. In this regard, the optical fiber exiting the termination arrangement 1706a (e.g., a first optical fiber segment) is routed through (e.g., is enclosed by) a first segment of a protective flexible conduit 1792a which terminates at a first splice box 1790a. Likewise, the optical fiber exiting the termination arrangement 1706b (e.g., a second optical fiber segment) is routed through a second segment of a protective flexible conduit 1792b which terminates at a second splice box 1790b. A third segment of flexible conduit 1792c joins the first splice box 1790a and the second splice box 1790b and a third optical fiber segment is routed through the flexible conduit 1792c to optically connect the first and second splice boxes. The first optical fiber segment and the third optical fiber segment are operatively spliced in the first splice box and the second optical fiber segment and the third optical fiber segment are operatively spliced in the second splice box, forming a continuous optical connection between the first and second optical fiber segments, and hence between the first electrical cable segment 1704a and the second electrical cable segment 1704b. The splice boxes 1790a and 1790b may include fusion splices, mechanical splices or any combination thereof.

The present disclosure also relates to cable splice arrangements for use with overhead electrical cables, such as cable splice 108b illustrated in FIG. 1. A cable splice arrangement for use with a fiber-reinforced composite strength member is disclosed, for example, in U.S. Pat. No. 7,019,217 by Bryant, which is incorporated herein by reference it its entirety. Although a cable splice maintains electrical conductivity between the two cable segments, the strength members of the two segments are separated within the splice. That is, there is a discontinuity of the strength member within the cable splice lying between two dead ends. Because of this discontinuity, the entire length of the cable between the two dead ends cannot be interrogated (e.g., using optical fibers) by using interrogation devices attached only at the termination arrangements. Thus, the present disclosure includes embodiments of a cable splice arrangement that permit interrogation of the strength member, e.g., from the cable splice to each of the dead ends, so that the entire length of the cable can be interrogated.

The foregoing embodiments are presented to illustrate termination arrangements and a splice arrangements that facilitate the interrogation of overhead electrical cables during and/or after installation of the electrical line (e.g., a distribution line or a transmission line). As such, the foregoing embodiments are subject to various modifications that are not specifically illustrated above. For example, the gripping elements are illustrated as comprising a collet-type grip having a collet and a collet housing. However, other types of gripping elements may be utilized. For example, a gripping element may include a direct compression device such as that illustrated in U.S. Pat. No. 6,805,596 by Quesnel et al. and assigned to Alcoa Fujikura Limited, which is incorporated herein by reference in its entirety.

In the embodiments of a termination arrangement, the jumper plate is illustrated as being disposed at the very proximal end of the conductive body. However, other arrangements are possible such as a “shark-fin” arrangement wherein the jumper plate is disposed closer to the middle of the conductive body.

The foregoing termination arrangements and cable splice arrangements may be utilized with a variety of electrical cables having strength members, particularly fiber-reinforced composite strength members. Interrogation techniques may include laser-based techniques such as optical time domain reflectometry (OTDR), or incoherent light techniques such as those disclosed in International Patent Publication No. WO 2019/168998 by Dong et al., which is incorporated herein by reference in its entirety.

It will be appreciated that the foregoing disclosure also relates to methods for securing an overhead electrical cable to a termination arrangement (e.g., to a dead-end), and to methods for interrogating a strength member through the hardware. The interrogation may occur after the overhead electrical cable has been fully tensioned and secured by the hardware, e.g., secured to a support tower as illustrated in FIG. 1. In one embodiment, a method for terminating an overhead electrical cable comprising a central strength member and a plurality of conductive strands wrapped around the strength member is disclosed, wherein the electrical cable is operatively secured to a support tower using a termination arrangement. Referring to FIG. 15 for purposes of illustration, the method may include the steps of removing a portion of the conductor (e.g., the conductive strands) from the strength member 1516 to expose an end segment of the strength member 1516. A termination arrangement 1506 is secured to the overhead electrical cable, where the termination arrangement includes a gripping assembly 1560 configured to grip the strength member 1516 (e.g., the end segment of the strength member) and a connector 1570 operatively attached to the gripping assembly 1560, the connector comprising a connector body 1573 and a connector body bore 1574 extending longitudinally from a first aperture in a proximal end of the connector body toward a distal end of the connector body. The termination arrangement 1506 is operatively secured to the overhead electrical cable by securing a first portion of the end segment of the strength member 1516 within the gripping element 1560, separating the one or more optical fibers 1522 from a second portion of the strength member end segment, cutting away excess length of the second portion of strength member 1516 and placing the second portion of the end segment of the strength member 1516 and the one or more optical fibers 1522 into the connector body bore 1574.

While various embodiments of configurations and methods for implementing the optical fibers in a strength member assembly and within an overhead electrical cable have been described in detail, it is apparent that modifications and adaptations of those embodiments will occur to those skilled in the art. However, it is to be expressly understood that such modifications and adaptations are within the spirit and scope of the present disclosure.

What is claimed is:

1. A method for the installation of an overhead electrical cable comprising a strength member assembly supporting an electrical conductor and at least one optical fiber operatively disposed along a length of the strength member assembly, the method comprising the steps of:
supporting the overhead electrical cable on a plurality of support towers;
removing a portion of the electrical conductor from an end segment of the strength member assembly;
securing a gripping assembly to the end segment of the strength member assembly, wherein a portion of the end segment extends past the gripping assembly;
separating an end portion of the optical fiber away from the portion of the end segment of the strength member that extends past the gripping assembly;
placing the separated end portion of the optical fiber through a fiber aperture at a distal end of a connector, wherein the connector comprises a fastener;
securing the connector to the gripping assembly;
crimping a conductive sleeve over the connector and over the electrical conductor; and
operatively connecting an interrogation device to the optical fiber.

2. The method recited in claim 1, wherein the gripping assembly comprises a collet having a collet bore that is disposed within a collet housing.

3. The method recited in any one of claims 1 or 2, wherein the step of securing the connector to the gripping assembly comprises threadably engaging the connector with the collet housing.

4. The method recited in any one of claims 1 to 3, wherein the optical fiber is disposed in a groove formed in an outer surface of the strength member.

5. The method recited in any one of claims 1 to 4, wherein the optical fiber is a coated optical fiber comprising a plastic coating surrounding the optical fiber and wherein the coating has a diameter of at least about 500 μm.

6. The method recited in claim 5, wherein the plastic coating has a diameter of at least about 700 μm.

7. The method recited in any one of claims 5 or 6, wherein the plastic coating is a high-performance plastic coating.

8. The method recited in claim 7, wherein the plastic coating is a thermoplastic coating.

9. The method recited in claim 8, wherein the thermoplastic coating is selected from a polyetheretherketone (PEEK) coating and a polyphenylene sulfide (PPS) coating.

10. The method recited in any one of claims 5 to 9, wherein the coated optical fiber is embedded in the strength member near an outer surface of the strength member.

11. The method recited in any one of claims 1 to 10, wherein the interrogation device is configured to measure mechanical strain along a length of the optical fiber.

12. The method recited in any one of claims 1 to 11, wherein the interrogation device is configured to measure temperature along a length of the optical fiber.

13. The method recited in any one of claims 1 to 12, further comprising the steps of:
detaching the interrogation device from the optical fiber; and
sealing the optical fiber within the connector by placing a cap over the fiber aperture.

14. The method recited in claim 13, wherein the sealing step comprises at least one of (i) cutting the separated end portion of the optical fiber; or (ii) inserting the separated end portion of the optical fiber into the connector, before placing the cap over the fiber aperture.

15. An overhead electrical line, comprising:
an overhead electrical cable supported on a plurality of support towers under mechanical tension, the overhead electrical cable comprising an electrical conductor supported by a strength member;
at least a first termination arrangement securing an end of the overhead electrical cable to a support tower, the termination arrangement comprising a gripping assembly secured to an end segment of the strength member;
an optical fiber extending along the length of the electrical cable and through the gripping assembly, and comprising an end portion past the gripping assembly that is separated from the strength member; and
an aperture disposed at an end of the termination arrangement that is configured to permit access to the optical fiber for the purpose of interrogating the optical fiber.

16. The overhead electrical line recited in claim 15, wherein the gripping assembly comprises a collet having a collet bore that is disposed within a collet housing.

17. The overhead electrical line recited in any one of claims 15 or 16, further comprising a connector secured to the gripping assembly, wherein the separated end portion of the optical fiber extends through a bore in the connector.

18. The overhead electrical line recited in any one of claims 15 to 17, wherein the optical fiber is disposed in a groove formed in an outer surface of the strength member.

19. The overhead electrical line recited in any one of claims 15 to 18, wherein the optical fiber is a coated optical fiber comprising a plastic coating surrounding the optical fiber and wherein the coating has a diameter of at least about 500 μm.

20. The overhead electrical line recited in claim 19, wherein the plastic coating has a diameter of at least about 700 μm.

21. The overhead electrical line recited in any one of claims 19 or 20, wherein the plastic coating is a high-performance plastic coating.

22. The overhead electrical line recited in claim 21, wherein the plastic coating is a thermoplastic coating.

23. The overhead electrical line recited in claim 22, wherein the thermoplastic coating is selected from a polyetheretherketone (PEEK) coating and a polyphenylene sulfide (PPS) coating.

24. The overhead electrical line recited in any one of claims 19 to 23, wherein the coated optical fiber is embedded in the strength member near an outer surface of the strength member.

25. An overhead electrical line, comprising:
a first segment of an overhead electrical cable, the first segment being secured to a dead-end tower using a first dead-end termination apparatus, the overhead electrical cable comprising an electrical conductor supported by a strength member;
a second segment of the overhead electrical cable, the second segment being secured to the dead-end tower in a substantially different direction than the first segment using a second dead-end termination apparatus;
a jumper cable electrically connecting the first segment to the second segment;
a first optical fiber segment extending from the first electrical cable, through the first dead-end termination apparatus and through a first segment of a protective flexible conduit terminating at a first splice box;
a second optical fiber segment extending from the second electrical cable, through the second dead-end termination apparatus and through a second segment of a protective flexible conduit terminating at a second splice box; and
a third segment of flexible conduit joining the first and second splice box, and a third optical fiber segment extending from the first splice box, though the third segment of flexible conduit, and into the second splice box,
wherein the first optical fiber segment and the third optical fiber segment are operatively spliced in the first splice box and the second optical fiber segment and the third optical fiber segment are operatively spliced in the second splice box.

26. The overhead electrical line recited in claim 25, wherein at least lone of the optical fiber segments are spliced by mechanical splices.

27. The overhead electrical line recited in any one of claims 25 and 26, wherein at least one of the optical fiber segments are spliced by mechanical splices.
